(19) United States
(12) Patent Application Publication
(10) Pub. No.: US 2026/0353260 A1
(43) Pub. Date: Nov. 5, 2026

(54) SYSTEM INFORMATION (RE)ACQUISITION

(71) Applicant: Telefonaktiebolaget LM Ericsson (publ), Stockholm (SE)

(72) Inventors: Zhang ZHANG, Beijing (CN); Bikramjit SINGH, KIRKKONUMMI (FI); Dung PHAM VAN, UPPLANDS VÄSBY (SE); Hamza KHAN, HELSINKI (FI)

(73) Assignee: Telefonaktiebolaget LM Ericsson (publ), Stockholm (SE)

(21) Appl. No.: 19/487,138

(22) PCT Filed: May 21, 2024
(86) PCT No.: PCT/SE2024/050494

§ 371 Date: Nov. 24, 2025

(30) Foreign Application Priority Data
May 26, 2023 (WO) PCT/CN2023/096685

(51) Int. Cl. H04W 48/16

(52) U.S. Cl. CPC H04W 48/16

(57) ABSTRACT

According to an aspect, there is provided a method performed by a user equipment, UE. The method comprises: determining whether to acquire or reacquire system information, SI, and, if it is determined to acquire or reacquire SI, acquiring or reacquiring the SI.

The project leading to this application has received funding from the European Union's Horizon 2020 research and innovation programme under grant agreement No 101095759.

### TECHNICAL FIELD

This disclosure relates to system information (SI) in a communication network, and in particular to techniques relating to the acquisition or reacquisition of SI.

### BACKGROUND

The 3^{rd} Generation Partnership Project (3GPP) Technical Standard (TS) 38.300 v17.3.0 (2022-12) provides an overall description of New Radio (NR), and NR and the Next Generation-Radio Access Network (NG-RAN).

SIB1 in NR—System Information Block 1 (SIB1) in New Radio (NR) includes parameters related to the following operations/configurations:
Cell selection
Cell access
Connection establishment failure control
Common serving cell configuration
Internet Protocol (IP) Multimedia Subsystem (IMS) Emergency Support
User Equipment (UE) timers and constants
Idle mode measurement
Unified Access Control (UAC) Barring
Small Data Transmission (SDT) configuration
Reduced Capability (RedCap) configuration
Hyper system frame number (SFN)
System Information (SI) Scheduling Info

Common serving cell configuration is used to configure cell specific parameters of a UE's serving cell in SIB1, which includes pagingSearchSpace configuration and searchSpaceOtherSystemInformation configuration. When the UE is provided with searchSpaceOtherSystemInformation on the active Bandwidth Part (BWP) or the initial BWP, the UE monitors the Physical Downlink Control Channel (PDCCH) addressed to SI-Radio Network Temporary Identifier (SI-RNTI) in searchSpaceOtherSystemInformation to obtain the scheduling info of the Physical Downlink Shared Channel (PDSCH) carrying a certain SI message which carry System Information Block(s) (SIB(s)) other than SIB1.

SI Scheduling Info contains information needed for (re)acquisition of SI messages. It indicates the type of a SIB; areaScope indicating whether the SIB is area specific, the valueTag of the SIB, a list of SIBs mapped to this SI-message; if the SI message is being broadcasted or not (in which case, it may also provide Physical Random Access Channel (PRACH) configuration needed by the UE to request for the required SI), periodicity of the SI message, etc.

SIB (re)acquisition in NR—The UE shall (re)acquire the system information (SI) upon cell selection (e.g. upon power on), cell-reselection, return from out of coverage, after reconfiguration with sync completion, after entering the network from another Radio Access Technology (RAT), upon receiving an indication that the system information has changed, upon receiving a Public Warning System (PWS) notification, upon receiving request (e.g., a positioning request) from upper layers; and whenever the UE does not have a valid version of a stored SIB or posSIB or a valid version of a requested SIB (the UE knows this by comparing the valueTag associated with the stored SIB or posSIB and that included in SIB1 for the corresponding SIB or posSIB. The stored SIB or posSIB is not valid if the two valueTag are not the same).

According to the 3^{rd} Generation Partnership Project (3GPP) Technical Specification (TS) 38.331 “NR; Radio Resource Control (RRC) protocol specification” v17.3.0 (2022-12), the UE shall:
1> delete any stored version of a SIB after 3 hours from the moment it was successfully confirmed as valid;
1> for each stored version of a SIB:
   2> if the areaScope is associated and its value for the stored version of the SIB is the same as the value received in the si-SchedulingInfo for that SIB from the serving cell:
      3> if the UE is Non-Public Network (NPN) capable and the cell is an NPN-only cell:
         4> if the first NPN identity included in the NPN-IdentityInfoList, the systemInformationAreaID and the valueTag that are included in the si-SchedulingInfo for the SIB received from the serving cell are identical to the NPN identity, the systemInformationAreaID and the valueTag associated with the stored version of that SIB:
         5> consider the stored SIB as valid for the cell;
      3> else if the first Public Land Mobile Network (PLMN)-Identity included in the PLMN-IdentityInfoList, the systemInformationAreaID and the valueTag that are included in the si-SchedulingInfo for the SIB received from the serving cell are identical to the PLMN-Identity, the systemInformationAreaID and the valueTag associated with the stored version of that SIB:
         4> consider the stored SIB as valid for the cell;

The UE may use a valid stored version of the SI except Master Information Block (MIB), SIB1, SIB6, SIB7 or SIB8 e.g. after cell re-selection, upon return from out of coverage or after the reception of SI change indication.

Short Message is used to indicate SI change and/or notify PWS (e.g. Earthquake and Tsunami Warning System (ETWS), Commercial Mobile Alert Service (CMAS)). It can be transmitted on PDCCH over Downlink Control Information (DCI) 1_0 using Paging-RNTI (P-RNTI) with or without associated Paging message. It has 8 bits, Table 1 below gives the definition of each bit.

TABLE 1
Short Message

| Bit | Short Message |
|---|---|
| 1 | systemInfoModification |
| | If set to 1: indication of a BCCH modification other than SIB6, SIB7 and SIB8. |
| 2 | etwsAndCmasIndication |
| | If set to 1: indication of an ETWS primary notification and/or an ETWS secondary |
| | notification and/or a CMAS notification. |
| 3 | stopPagingMonitoring |
| | This bit can be used for only operation with shared spectrum channel access and if |
| | nrofPDCCH-MonitoringOccasionPerSSB-InPO is present. |
| | If set to 1: indication that the UE may stop monitoring PDCCH occasion(s) for paging in this |
| | Paging Occasion as specified in TS 38.304 [20], clause 7.1. |
| 4 | systemInfoModification-eDRX |
| | If set to 1: indication of a BCCH modification other than SIB6, SIB7 and SIB8. This |
| | indication applies only to UEs using eDRX cycle longer than the BCCH modification period. |
| 5-8 | Not used in this release of the specification, and shall be ignored by UE if received. |

In Table 1, TS 38.304 refers to 3GPP TS 38.304 “NR; User Equipment (UE) procedures in Idle mode and in RRC Inactive state” v17.3.0 (2022-12).

In Table 1, BCCH is Broadcast Control Channel, eDRX is extended DRX (Discontinuous Reception).

If a UE receives a Short Message, the UE shall:
1> if the UE is ETWS capable or CMAS capable, the etwsAndCmasIndication bit of Short Message is set, and the UE is provided with searchSpaceSIB1 and searchSpaceOtherSystemInformation on the active BWP or the initial BWP:
   2> immediately re-acquire the SIB1;
   2> if the UE is ETWS capable and si-SchedulingInfo includes scheduling information for SIB6:
      3> acquire SIB6 immediately;
   2> if the UE is ETWS capable and si-SchedulingInfo includes scheduling information for SIB7:
      3> acquire SIB7 immediately;
   2> if the UE is CMAS capable and si-SchedulingInfo includes scheduling information for SIB8:
      3> acquire SIB8 immediately;
1> if the UE is not configured with an eDRX cycle longer than the modification period and the systemInfoModification bit of Short Message is set:
   2> re-acquire SIB1 from the start of the next modification period, determine from SIB1 which other SIB(s) are changed and re-acquire the SI message(s) carrying the changed SIB(s) from the start of the next modification period;
1> if the UE is configured with an RRC_IDLE eDRX cycle longer than the modification period and the systemInfoModification-eDRX bit of Short Message is set:
   2> re-acquire SIB1 from the start of the next eDRX acquisition period boundary, determine from SIB1 which other SIB(s) are changed and re-acquire the SI message(s) carrying the changed SIB(s) from the start of the next eDRX acquisition period boundary;

Zero energy Internet of things (ZE-IoT)—ZE-IoT devices differ from smart phones in a variety of ways. For example, ZE-IoT devices typically handle comparatively small amounts of data and are instead optimised to prioritise battery life. ZE-IoT devices can be required to remain operational for long durations (e.g. a decade or more) without recharging or replacing their batteries. Passive ZE-IoT devices have no battery at all and instead rely on harvesting energy from different sources such as wind, radio frequency (RF), solar, or vibrations.

ZE-IoT devices remain in sleep (i.e. in a sleep mode) for long durations and only wake up to perform an operation when having harvested sufficient energy, for instance a sensor that wakes up monthly to report a reading and then returns to sleep. ZE-IoT devices typically do not interact with users, instead, they rely more on autonomous forms of management and control within the devices themselves or the networks with which they communicate. Besides, services run by ZE-IoT devices can tolerate a relatively long latency as ZE-IoT devices remain in sleep for long durations and the services can only be run when ZE-IoT devices are awake.

Ambient IoT in 3GPP—In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billions of IoT devices for various applications and provide added value across the entire value chain. It is impossible to power all the IoT devices by batteries that need to be replaced or recharged manually, which would lead to a high maintenance cost, serious environmental issues, and even safety hazards for some use cases, for example, wireless sensors in electrical power and petroleum industries.

Most of the existing wireless communication devices are powered by batteries that need to be replaced or recharged manually. The automation and digitisation of various industries opens numerous new markets requiring new IoT technologies of supporting battery-less devices with no energy storage capability, or devices with energy storage that do not need to be replaced or recharged manually.

An example type of application is asset identification, which presently has to resort mainly to barcodes and Radio Frequency Identifiers (RFID) in most industries. The main advantage of these two technologies is the ultra-low complexity and small form factor of the tags. However, the limited reading range of a few meters usually requires handheld scanning which leads to labour intensive and time-consuming operations, or RFID portals/gates which leads to costly deployments. Moreover, the lack of interference management scheme results in severe interference between RFID readers and capacity problems, especially in case of dense deployment. It is hard to support a large-scale network with seamless coverage for RFID.

In light of above, the 3^{rd} Generation Partnership Project (3GPP) has defined a Study Item (SI) “Ambient IoT” in Release 18 to cover the scope and study related to such ultra-low power IoT devices which can be integrated into 3GPP networks. It is a new and ongoing study and the present Technical Report (3GPP TR 38.848 “Study on Ambient IoT (Internet of Things) in RAN (Release 18)” v0.0.2 (2022-12)) briefly specifies information related to the feasibility of meeting the design targets for relevant use cases of a new 3GPP IoT technology, on the basis of suitable deployment scenarios in a 3GPP system, which relies on ultra-low complexity devices with ultra-low power consumption for very-low end IoT applications. It intends to provide a clear differentiation, i.e., addressing use cases and scenarios that cannot otherwise be fulfilled based on existing 3GPP Low Power Wide Area (LPWA) IoT technology.

In terms of energy storage, the study considers the following device characteristics:
Pure battery-less devices with no energy storage capability at all, and completely dependent on the availability of an external source of energy.
Devices with limited energy storage capability that do not need to be replaced or recharged manually.

The study investigates the feasibility of a new IoT technology to open new markets within 3GPP systems, whose number of connections and/or device density can be orders of magnitude higher than existing 3GPP IoT technologies, and which can provide complexity and power consumption orders-of-magnitude lower than existing 3GPP LPWA technologies such as NB-IoT and Long Term Evolution (LTE)—Machine-Type Communication (MTC).

### SUMMARY

There currently exist certain challenge(s). The current SI (re)acquisition mechanism is not suitable for ZE-IoT devices, for several reasons.

Currently, SIB1 always needs to be (re)acquired after power on (e.g. after harvesting enough energy), cell re-selection, upon return from out of coverage or after the reception of SI change indication and/or PWS notification. (Re)acquiring SIB1 is unnecessary if it consumes the limited energy harvested by ZE-IoT devices and little or no energy remains to run the service(s) that the ZE-IoT devices are operating.

A SI message needs to be (re)acquired when one or more SIB(s) carried in the SI message are changed. This also leads to ZE-IoT devices having less energy or even no energy remaining to run the service(s) they are operating. Besides, the changed SIB(s) may not be relevant to the service(s) being operated, and in this case (re)acquiring the SI message is useless but just consumes the limited energy harvested by ZE-IoT devices.

A UE must delete a stored version of SIB after every 3 hours from the moment it was successfully confirmed as valid. This means the UE needs to (re)acquire SIB every 3 hours. On the other hand, a ZE-IoT UE may wake up once per day, per week or even per month, which means the ZE-IoT UE may always need to first (re)acquire SIB when it wakes up, which is quite energy unfriendly/inefficient to a ZE-IoT UE.

Certain aspects of the disclosure and their embodiments may provide solutions to these or other challenges. In particular, this disclosure proposes methods for (re)acquiring SIB (including SIB1 and/or other SIBs) in a more energy efficient way, for example that is adapted to characteristics of ZE-IoT UEs, including the corresponding criteria, signalling design, network (NW) behaviour and UE behaviour.

Aspects of this disclosure relate to the following:
Criteria for postponing (re)acquisition of SIB1.
Indicating in short message which SIB(s) or SI message(s) are or will be changed, and a UE directly (re)acquires the changed SIB(s) or SI message(s) without (re)acquiring SIB1.
   Such indication may only be introduced for specific SIB(s) or SI message(s).
Indicating whether or not SIB (re)acquisition can be postponed.
A procedure for the UE to (re)acquire SIB when the postponement is allowed/not forbidden.
Introduction of ZE-IoT specific SIB(s) containing important/essential system information for ZE-IoT, and ways to (re)acquire such SIB(s) only when the SIB(s) are/may be changed.
UE behaviour on SIB (re)acquisition when valueTag indicates both essential and non-essential information updates in a SIB.
Directly trying to (re)acquire ZE-IoT specific SIB(s) based on the stored info without first (re)acquiring MIB and SIB1.
Including some critical information from MIB/SIB1 in ZE-IoT specific SIB(s), which allows a determination whether the acquired ZE-IoT specific SIB(s) is valid.

According to a first aspect, there is provided a method performed by a UE. The method comprises determining whether to acquire or reacquire system information (SI), and if it is determined to acquire or reacquire SI, acquiring or reacquiring the SI.

According to a second aspect, there is provided a method performed by a network node. The method comprises transmitting one or more of: an indication of a remaining time period in which System Information (SI) will not be changed by the network; a threshold that the remaining time period is to be compared with; an indication of whether the remaining time period is less than the threshold; a valueTag parameter; a message indicating SI in System Information Blocks (SIBs) that is or will be changed; a message indicating SI in SIBs other than SIB1, that is or will be changed; a message indicating that one or more UEs are allowed to postpone acquiring or reacquiring SI; and a set of one or more System Information Blocks (SIBs) comprising only SI for use by Internet of Things (IoT) UEs.

According to a third aspect, there is provided a computer program product comprising a computer readable medium having computer readable code embodied therein, the computer readable code being configured such that, on execution by a suitable computer or processor, the computer or processor is caused to perform the method according to the first aspect, the second aspect, or any embodiments thereof.

According to a fourth aspect, there is provided a UE configured to perform the method according to the first aspect or any embodiment thereof.

According to a fifth aspect, there is provided a UE comprising a processor and a memory, said memory containing instructions executable by said processor whereby said UE is operative to perform the method according to the first aspect or any embodiment thereof.

According to a sixth aspect, there is provided a network node configured to perform the method according to the second aspect or any embodiment thereof.

According to a seventh aspect, there is provided a network node comprising a processor and a memory, said memory containing instructions executable by said processor whereby said network node is operative to perform the method according to the second aspect or any embodiment thereof.

Certain embodiments may provide one or more of the following technical advantage(s). By applying the methods proposed herein, unnecessary SIB (re)acquisition can be avoided, and SIB (re)acquisition can be performed in a more energy efficient way. This is important for ZE-IoT UEs, which rely on ultra-low complexity devices with ultra-low power consumption.

### BRIEF DESCRIPTION OF THE DRAWINGS

Some of the embodiments contemplated herein will now be described more fully with reference to the accompanying drawings, in which:

FIG. 1 is a flow chart illustrating a method performed by a user equipment in accordance with some embodiments;

FIG. 2 is a flow chart illustrating a method performed by a network node in accordance with some embodiments;

FIG. 3 shows an example of a communication system in accordance with some embodiments;

FIG. 4 shows a UE in accordance with some embodiments;

FIG. 5 shows a network node in accordance with some embodiments; and

FIG. 6 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

The terms “power” and “energy”, etc. are used interchangeably herein. The terms “power” or “energy” do not discount other terminologies or Key Performance Indicators (KPIs) which are indicative of such quantities or function of used terms.

The embodiments are described based on 3GPP New Radio (NR). However, the techniques are applicable to any kind of existing or future Radio Access Technology (RAT) that use similar messages/signalling, albeit that the messages/signalling may have different names/structures.

The terms “acquire” and “reacquire” are used interchangeably herein with reference to system information/SIBs.

The techniques described herein are applicable to any kind of UEs, although the techniques are motivated by ZE-IoT UEs or (ultra) low-power UEs with limited or no energy storage, which can also be classified as active, passive, or semi-passive UE.

(Re)Acquisition Mechanisms for ZE-IoT with Active Timers

In this section, it is assumed that UEs are active devices, i.e. when they are sleep or their receiver is inactive or switched/powered off, they still retain the configured timers running. This is because they have limited energy storage capacity, so when the receiver is off, the devices can still run their timers.

This disclosure proposes SI (re)acquisition mechanisms which are more energy efficient and adapt to characteristics of ZE-IoT UEs. The mechanisms consider both (re)acquisition of SIB1 and that of SI messages carrying other SIB(s). In addition, the mechanisms cover also the case where essential system information for Ambient-IoT/ZE-IoT devices is contained in one or several newly introduced SIBs.

The techniques described herein are presented below in a series of embodiment ‘sets’. While these embodiment sets are generally described separately, it will be appreciated that one or more of these embodiment sets can be implemented in combination with each other.

In a first set of embodiments, it may be indicated in, e.g., MIB, a remaining time period after which SIB1 can be changed. That is, the remaining time period is used by the network to indicate a period during which SIB1 will not be changed, and thus can be used by a UE to determine that it is not necessary to (re)acquire SIB yet. The time period may be indicated in physical time (e.g. seconds, minutes, hours, days, etc.), number of System Frame Number (SFN), number of Hyper SFN, or number of (e)DRX cycles, etc. Alternatively, the MIB may just indicate whether the remaining time period is smaller than a threshold, and it is up to the UE to determine how much time to wait before (re)acquiring SIB1. This threshold may be set by the network, or may be set based on a capability of the UE.

A UE may evaluate one or more of the conditions set out below to determine whether or not to (re)acquire SIB1. The UE can evaluate this/these condition(s) and determine not to (re)acquire SIB1, even if the legacy conditions for (re)acquiring SIB1 (as described above) are met. These legacy conditions include after power on (e.g. after harvesting enough energy), after cell re-selection, upon return from out of coverage or after the reception of a SI change indication and/or a PWS notification.

The condition(s) that the UE can evaluate can include any of:
whether the remaining time period is smaller than a threshold, where the threshold may be indicated in MIB or defined in a specification (e.g. a 3GPP specification). The condition is met (and SIB is not (re)acquired) if the remaining time period is smaller than the threshold. The threshold allows a UE to set a longer time (than the remaining time period) to wait before (re)acquiring SIB1 in case the remaining time period is small (e.g. smaller than the threshold). The threshold can be common for different types of IoT devices, or can be device category specific. For example, different types of IoT tags/sensors may be configured with different threshold values. In this case the UE may postpone SIB1 (re)acquisition for a time period which is equal to or larger than the remaining time period or the time period threshold (preferably the larger one of the two). The intention is to avoid frequent SIB1 (re)acquisition within a short time period.
whether the remaining energy after (re)acquiring SIB1 is enough to complete transmission/reception of at least one packet in UL/DL. This condition is met (and SIB is not (re)acquired) if the remaining energy is not sufficient to complete a transmission/reception of at least one packet in UL/DL. In this case the UE may continue harvesting/storing energy and (re)acquire SIB1 once enough energy is harvested/stored.

When the UE suspends SIB1 (re)acquisition (i.e. decides not to (re)acquire yet), the UE may also suspend one or more of the operations listed below. This is because these operations may not be performed properly if SIB1 was not (re)acquired, but this is typically acceptable for ZE-IoT UEs which are delay tolerant. The operations include:
(Re)acquiring other SIB(s) or SI message(s) carrying other SIB(s)
Monitoring DL paging (which implies the UE will not monitor SI change indication and/or PWS notification)
DL measurement, if applicable
Signalling/data reception in DL
Signalling/data transmission in UL

In a second set of embodiments, a short message (e.g. DCI scrambled with P-RNTI) may directly indicate which SIB(s) or SI message(s) is or will be changed. From this, the UE can directly (re)acquire the changed SIB(s) or SI message(s) carrying the changed SIB(s) without having to (re)acquire SIB1. The SIB(s) or SI message(s) that is or will be changed may be indicated using one or more reserved bit(s) and/or new introduced bit(s), where each bit can indicate whether a specific SIB or SI message is or will be changed or not.

In some embodiments, a bit associated to a specific SIB or SI message is set (by setting the bit to either 1 or 0) only when the SIB or SI message is or will be changed. As an example, the mapping between the reserved bits in the short message and the SIBs or SI messages of interest may be defined in a specification (e.g. 3GPP specification), or signalled to UEs, e.g. via MIB signalling.

To limit the overhead associated with such an indication, one or more of the following measures may be adopted:
Such an indication may only be introduced for SIB(s) belonging to a specific set of SIB(s) or SI message(s) carrying SIB(s) belonging to a specific set of SIB(s). The SIB set may be indicated in, e.g., MIB or SIB1. In some embodiments, a bit associated to one of such SIB(s) or SI message(s) carrying SIB(s) belonging to a specific set of SIB(s) can be set only when the SIB or SI message is or will be changed (e.g. by setting the bit to either 1 or 0.
Such an indication may only be introduced for SIB(s) containing specific parameter(s) or SI message(s) carrying SIB(s) containing specific parameter(s) (e.g., parameters related to cell selection, cell reselection, common cell configuration, measurement, etc.). A bit associated to one of these SIB(s) or SI message(s) carrying the SIB(s) is set (by setting the bit to either 1 or 0) only when one or more of the specific parameter(s) contained in the SIB or SIB(s) carried by the SI message is or will be changed.

In some embodiments, the UE may only (re)acquire SIB1 if the short message indicates a SIB change and/or notifies PWS, and no bit related to a specific SIB or SI message (as described above) is set. This can help further reduce the need for UEs to acquire SIB1.

In a third set of embodiments, the short message may indicate whether the UE is allowed to postpone (re)acquiring the changed SIB. This indication may use a reserved bit in the short message, or a new bit introduced for this purpose. The bit is set (by setting the bit to either 1 or 0) if the postponement is allowed. If a UE receives a short message indicating SIB change and/or notifying PWS and the postponement indication is set, the UE may (re)acquire SIB1 and/or other changed SIB(s) or SI message(s) carrying the changed SIB(s) at a later time. That is, the UE may not perform the (re)acquisition immediately upon receiving the short message, or at the start of the next modification period, or at the start of the next eDRX acquisition period boundary). Embodiments indicating when to perform the (re)acquisition are provided below with reference to the fifth set of embodiments.

In some embodiments, the postponement indication in the short message may only be relevant to a specific UE or specific category of UEs (e.g. it is only relevant/applicable to ZE-IoT UEs). In this case, the restriction/limitation may be indicated in common control signalling (e.g. SIB1), dedicated control signalling (e.g. Non-Access Stratum (NAS)), or be defined in a specification. In some embodiments, ‘irrelevant’ UEs (i.e. UEs other than the specific UE, or UEs not in the specific category of UEs), will ignore the postponement indication in the short message, and perform the SI (re)acquisition as if the postponement indication is not set. In other embodiments, an indication may be provided as to whether the irrelevant UEs shall perform the (re)acquisition as if the postponement indication is set or as if the postponement indication is not set. This indication can be indicated in common control signalling (e.g. SIB1), dedicated control signalling (e.g. NAS), or defined in a specification.

In some embodiments, the irrelevant UEs (i.e. UEs other than the specific UE, or UEs not in the specific category of UEs) or the ‘relevant’ UEs (i.e. the specific UE, or the specific category of UEs) that are allowed to postpone SI (re)acquisition while no postponement indication is provided in the short message may be identified in common control signalling (e.g. SIB1), dedicated control signalling (e.g. NAS), or defined in the specification. A particular UE may postpone SIB or SI message (re)acquisition if that is allowed.

In further embodiments, a postponement indication in the short message may be used to override an indication in common control signalling (e.g. in SIB1), in dedicated control signalling (e.g. in NAS), or that is defined in a specification. For instance, a UE shall not/may postpone SIB or SI message (re)acquisition if that is not/is allowed according to the received short message, even though it is/is not allowed according to that indicated in common control signalling (e.g. SIB1), dedicated control signalling (e.g. NAS) or defined in a specification.

In a fourth set of embodiments, it may be that most or all of the important/essential system information for Ambient-IoT UEs and/or ZE-IoT UEs is contained in one or several SIB(s) dedicated for IoT. In this case, it can be specified that the DCI scheduling the IoT-specific SIB(s) (noting that this DCI is different to the “short message” described above) includes the indication that allows the IoT devices to postpone/skip acquisition of the SIB(s) due to, e.g., no change in essential information. The IoT specific SIB(s) can be newly defined SIB(s), e.g. denoted SIB1-IoT, SIBx-IoT, etc. Alternatively, the IoT specific SIB(s) can be based on an extension of existing SIB(s) in 5^{th} Generation (5G) NR.

In one example, all IoT-specific essential information is included in an extended SIB1. In this example, i.e. extended SIB1 in 5G NR, one bit (a new bit or a reserved bit) in the DCI used to schedule SIB1 can be used as a 1-bit flag to indicate whether IoT devices can postpone/skip the acquisition of SIB1 or not. If the UE misses the PDCCH in one modification period e.g., due to energy depletion, it may receive the SIB in the next modification period even if the PDCCH indicates no changes in the IoT-specific SIB(s) or in the IoT-specific essential information in the existing SIB. In some cases, if one or more new SIBs specific for Ambient-/ZE-IoT UEs is used, a long modification period for the IoT specific SIBs can be defined and configured to allow for reduced monitoring of the SIBs.

In some embodiments, the MIB can contain both the critical information for the reception of SIB1 for normal UEs (i.e. pdcch-ConfigSIB1), and the critical information for the reception of IoT-specific SIB1 for ZE-IoT UEs (denoted pdcch-ConfigSIB1-IoT) where the IoT-specific SIB1 is a simplified version of SIB1 containing only the critical information essential for ZE-IoT UEs. In this case, the ZE-IoT UEs need not to decode the SIB1 designed/intended for regular UEs and can (re)acquire the SIB1_IoT based on pdcch-ConfigSIB1-IoT provided in MIB (when it has enough energy).

In some embodiments, a restriction for (re)acquiring SIB(s) can be defined for ZE-IoT UE. For instance, the ZE-IoT UE may only need to delete any stored version of a SIB after N hours from the moment it was successfully confirmed as valid. In some embodiments, N can be (much) larger than 3. This means that a IoT UE does not need to (re)acquire a SIB (at least) every N hours. Furthermore, when IoT-specific SIB(s) are defined, an IoT UE is only required to (re)acquire the IoT specific SIB(s) with such new restriction applied. The value of N may be defined in a specification, preconfigured in the UE, or indicated in MIB, SIB1 and/or SIB1_IoT, and may be different for different IoT-specific SIB(s) or different types of IoT UE.

In a fifth set of embodiments, it can be up to UE implementation to determine when to acquire/reacquire a changed SIB or a SI message carrying changed SIB(s). This decision according to UE implementation can be performed either with or without a definition in the specification or a configuration/indication from the network on whether/when the (re)acquisition of the SIB(s) or SI message(s) can be postponed. For instance, the UE may reacquire a SIB or a SI message any time between the time the UE determines that the SIB or one or more SIB(s) carried in the SI message was changed and the time that it needs to perform an action where the action requires parameters included in the changed SIB or changed SIB(s) carried in the SI message. These actions can include any of perform a measurement, perform a cell (re)selection, monitor paging, perform random access, etc.

The UE can determine that a SIB is changed if any one or more of the following conditions are satisfied:
The SIB has not been acquired before or not been stored
Upon cell (re)selection
Return from out of coverage
The stored SIB is no longer valid according to the valueTag associated with the stored SIB and that is included in SIB1
The UE receives a short message indicating SI change and/or notifying PWS
The UE receives a short message indicating the SIB is changed
The UE has not received/monitored a short message and/or the SIB for at least one modification period or one eDRX acquisition period since the last time the short message and/or the SIB was received/monitored. This may be due to the UE having run out of energy and went into sleep.

In a sixth set of embodiments, the UE behaviour can be defined subject to the information type contained in valueTag parameter. The valueTag parameter can be included in SIB1 and used to indicate whether a specific SIBx has changed. For instance, whether or not a UE will/may (re)acquire a SIB depends on if the valueTag associated to the SIB indicates essential or non-essential information updates in the SIB. In one example, the valueTag associated to a SIB can be divided into two parts—one part that to indicates whether or not the essential information is updated in the SIB (e.g. denoted valuetag_essential) and the other is to indicate whether or not non-essential information is updated in the SIB (e.g. denoted valuetag_nonessential). The UE can read both parts, and depending on the value of valuetag_essential and valuetag_nonessential, it may or may not perform/delay the re-acquisition of the SIB. Table 2 below provides an example demonstrating the UE behaviour for different ValueTag values.

TABLE 2

| ValueTag for corresponding SIBx | | |
|---|---|---|
| ValueTag_Essential | ValueTag_NonEssential | UE behavior |
| Set (i.e., essential | Set (i.e., non-essential | UE will (re)acquire the |
| information is updated) | information is updated) | corresponding SIB |
| | | immediately |
| Set (i.e., essential | Not Set (i.e., non- | UE will (re)acquire the |
| information is updated) | essential information is | corresponding SIB |
| | NOT updated) | immediately |
| Not Set (i.e., essential | Set (i.e., non-essential | UE will/is allowed to delay |
| information is NOT | information is updated) | or postpone the |
| updated) | | (re)acquiring of the |
| | | corresponding SIB |
| Not Set (i.e., essential | Not Set (i.e., non- | UE will not (re)acquire the |
| information is NOT | essential information is | corresponding SIB |
| updated) | NOT updated) | |

In an extension of the sixth set of embodiments, a valueTag can indicate (essential) information updates for specific UE/service class types. For instance, a valueTag may be introduced indicating whether or not the (essential) information that applies (only) to ZE passive devices or ZE active devices or to their related services is updated. In one example, the valueTag can correspond to (essential) information mapped to two UE classes, say, ZE passive UEs and ZE active UEs. In another example, the valueTag can correspond to both essential and non-essential information, where the essential information applies to ZE passive devices and non-essential information applies to ZE active device (and other IoT UE device).

(Re)Acquisition Mechanisms for ZE-IoT Device with Non-Active Timers

This section relates primarily to UEs that are passive devices, i.e. when they are inactive or their receiver is inactive, or switched/powered off, they cannot retain any timers. This is because they don't contain enough energy storage capacity, so when receiver is off, the device cannot run its timers. However, it will be appreciated that the embodiments described here are also applicable to ZE-IoT device with active timers.

In some embodiments, once the IoT UE is powered on, gets woken up after sleep or after harvesting (enough) energy, it does not acquire MIB and SIB1, and instead it directly acquires the relevant SIB(s), e.g. an SIB for IoT UEs, say SIBx.

One policy is that the UE saves some, most or all of the critical MIB information and SIB1 information in its memory (e.g. a non-volatile memory) when it was previously acquired or reacquired. Hence, after sleep, the UE will not have lost the information, and the content remains available. With the help of this information, e.g., the resource allocation and decoding parameters for SIBx, the UE can directly try to (re)acquire SIBx which is meant for IoT UEs without first (re)acquiring MIB and SIB1.

In case the network has changed the SIBx decoding information, which may have been indicated by the network in, e.g., SIB1, then the UE may be unable to decode or (re)acquire SIBx without first (re)acquiring SIB1 and/or MIB or their combinations, etc. In this case the UE may (re)acquire SIB1 and/or MIB.

A procedure for directly (re)acquiring of SIBx is outlined below:
The UE powers on (e.g. wakes up after harvesting (enough) energy), or changing cell, re-camping, etc.
The UE searches for SIBx (the UE has stored related information for SIBx reception and decoding provided by MIB and SIB1 which it had acquired and saved in its memory).
If SIBx is:
   not detected, then the UE checks and tries to acquire MIB and SIB1;
      This may happen when the resource allocation window of SIBx has changed or decoding parameters of SIBx have changed.
   detected, the UE decodes SIBx and applies the parameters included in SIBx in the relevant procedures.

In another embodiment, the network may also include some of the most critical information from MIB/SIB1 in SIBx. The reason is that the UE is bypassing MIB/SIB1 (i.e. not acquiring/reacquiring MIB/SIB1), so it is important to include the most important information from MIB/SIB1 in SIBx. One example is to include cell barring information in SIBx. Currently this information is included in the MIB, but as UE has skipped the MIB, it should be included also in SIBx.

Correspondingly, the UE may try to decode SIBx in a stepwise manner, where if certain conditions are met, the UE will regard the information included in SIBx as valid and apply the information when needed. Otherwise the UE will regard the information included in SIBx as invalid, and may possibly start (re)acquiring SIBx or MIB/SIB1 from another cell at a later time, etc. The condition may be evaluated based on the critical information in SIBx where the critical information may be from MIB/SIB1.

The evaluation of a condition based on the cell barring information is outlined below.
In case the detected cell barring information (in SIBx or MIB) indicates the cell is barred, the UE can suspend SIB (re)acquisition and (re)acquire SIBx or MIB/SIB1 when certain conditions are met, e.g., after a certain period (the period may only be counted when the UE is awake and has timer running) and/or when the UE wakes up next time (the UE may directly go into sleep if the cell is barred) and/or when the UE moves to and reselects another cell.
Otherwise, the UE can continue to receive/decode SIBx and apply the parameters included in SIBx in the relevant procedures.

For ZE-IoT UE there could be a static configuration for SIBx reception and decoding, and also for the critical information in MIB/SIB1. Meanwhile, the configuration could be the same in a large area or even the whole network. Directly trying to (re)acquire IoT specific SIB without first (re)acquiring MIB and SIB1 could evidently save energy for IoT UE.

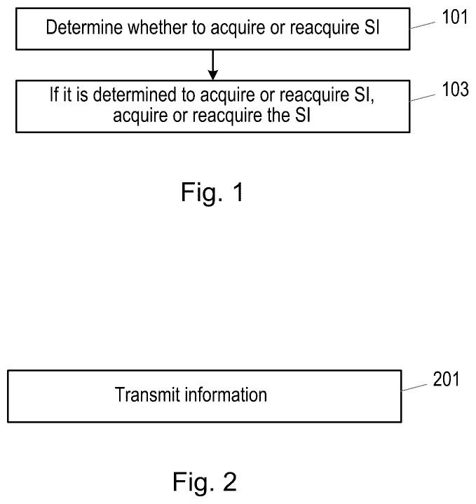

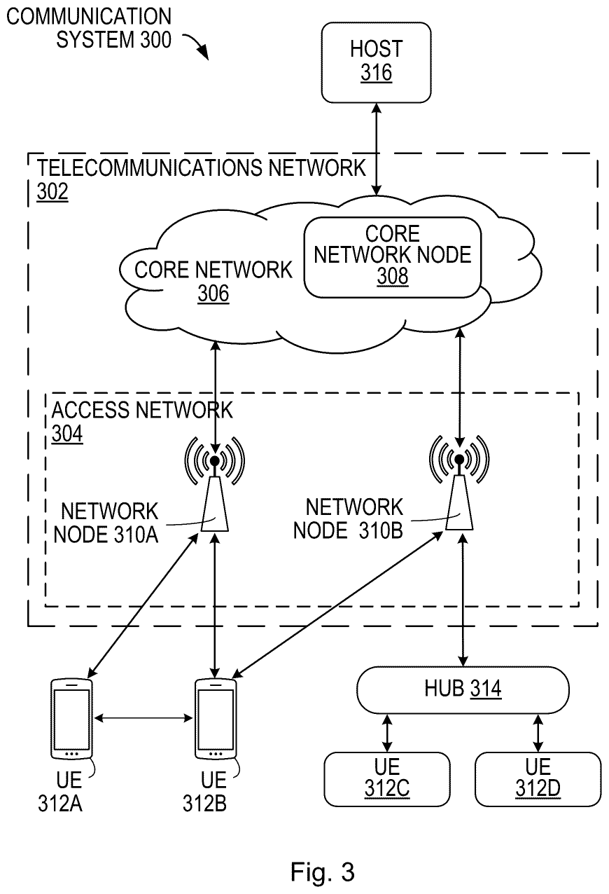

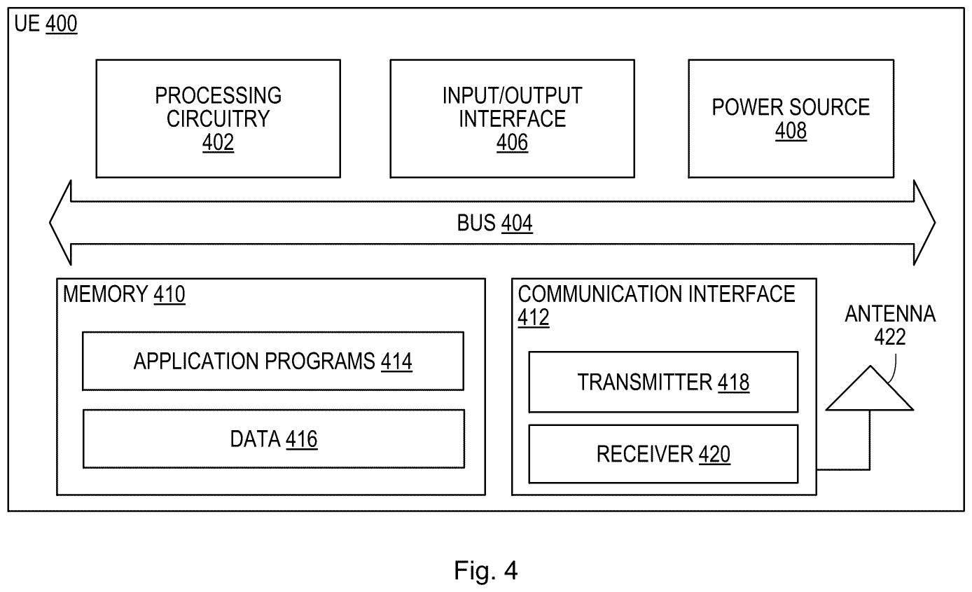

FIG. 1 is a flow chart illustrating a method performed by a UE in accordance with some embodiments. The UE may perform the method in response to executing suitably formulated computer readable code. The computer readable code may be embodied or stored on a computer readable medium, such as a memory chip, optical disc, or other storage medium. The computer readable medium may be part of a computer program product. The UE may be the UE 312 or UE 400 as described later with reference to FIGS. 3 and 4 respectively.

In step 101, the UE determines whether to acquire or reacquire SI.

If in step 101 it is determined to acquire or reacquire SI, then in step 103 the UE acquires or reacquires the SI.

The SI that can be acquired or reacquired can relate to SI in SIB1. Alternatively, the SI that can be acquired or reacquired can be SI in a set of one or more SIBs that only comprise SI for use by IoT UEs.

Determining whether to acquire or reacquire the SI in step 101 can be based on any one or more of the following:
an indication of a remaining time period during which SI will not be changed by the network (this indication can be received from a network node, for example in a MIB);
a comparison of the remaining time period and a threshold (in particular step 101 can comprise determining not to acquire or reacquire SI if the remaining time period is less than the threshold) (the threshold can be received from a network node, for example in a MIB);
an indication of whether the remaining time period is less than the threshold (this indication can be received from a network node, for example in a MIB);
an energy level of the UE;
an estimate of the energy level of the UE after acquiring or reacquiring the SI;
a comparison of the energy level or estimated energy level to an amount of energy required by the UE to acquire or reacquire the SI;
a comparison of the energy level or estimated energy level to an amount of energy required by the UE to transmit data and/or receive data after acquiring or reacquiring the SI;
determining that the SI has changed;
whether the UE is to perform an action that applies or uses the SI; and
a valueTag parameter (for example indicating a type of information that has been changed in SI, or for example indicating whether essential SI has changed).

In particular embodiments, step 101 can comprise determining not to acquire or reacquire SI if the energy level or estimated energy level is below an amount required to acquire or reacquire the SI. In other particular embodiments, step 101 can comprise determining not to acquire or reacquire SI if the energy level or estimated energy level is below an amount required to transmit data and/or receive data after acquiring or reacquiring the SI.

In embodiments where the decision whether to acquire or reacquire the SI in step 101 is based on determining that the SI has changed, the UE can determine that the SI has changed if any one or more of the following apply:
the SI has not been acquired and/or the SI has not been stored;
the UE selects or reselects a cell;
the UE returns from out of coverage;
SI stored by the UE is no longer valid
a message is received indicating that SI or a System Information Block, SIB, has changed;
a message is received indicating that there is an emergency situation; and/or
the UE has not received the SI or a SIB for at least one modification period or an eDRX acquisition period.

In some embodiments, the SI is in System Information Block 1 (SIB1), and the UE can receive a message indicating SI in other SIBs that is or will be changed. In this case, the UE can determine not to acquire or reacquire the SI in SIB1. Alternatively or in addition, the UE can acquire or reacquire the SI in the other SIBs indicated in the message.

In some embodiments, the UE can receive a message indicating SI and/or one or more SIBs that is or will be changed. The received message can relate to a specific set of SI messages or SIBs, or relate to one or more SIBs comprising one or more specific parameters. The message can be received in a MIB or SIB1.

In any of the embodiments where the UE receives a message, the message can be a DCI message. The DCI message may comprise one or more bits used to indicate whether a respective SI or SIB is or will be changed. The DCI message can be scrambled with any of: an identifier for the UE, a RNTI for the UE, and a P-RNTI for the UE.

The UE may receive a message indicating whether the UE is allowed to postpone acquiring or reacquiring the SI. In these embodiments, if the received message indicates that the UE is allowed to postpone acquiring or reacquiring the SI, step 101 can comprise determining to postpone acquiring or reacquiring the SI. After postponing the acquisition or reacquisition of the SI, the UE can acquire or reacquire the SI prior to an action by the UE that requires information in the SI. The indication of whether the UE is allowed to postpone acquiring or reacquiring the SI can be a bit. The indication of whether the UE is allowed to postpone acquiring or reacquiring the SI can be received in SI, a SIB, or in dedicated control signalling.

In some embodiments, the SI is SIB1, and if it is determined in step 101 that SIB1 is not to be acquired or reacquired, the UE can acquire or reacquire SI in SIBs other than SIB1, without acquiring or reacquiring SIB1 or a Master Information Block (MIB).

If it is determined in step 101 that the SI in SIB1 is not to be acquired or reacquired, the UE can suspend one or more of: acquiring or reacquiring SI other than SIB1; paging monitoring; downlink (DL) measurements; signalling/data reception in DL; and signalling/data transmission in uplink (UL).

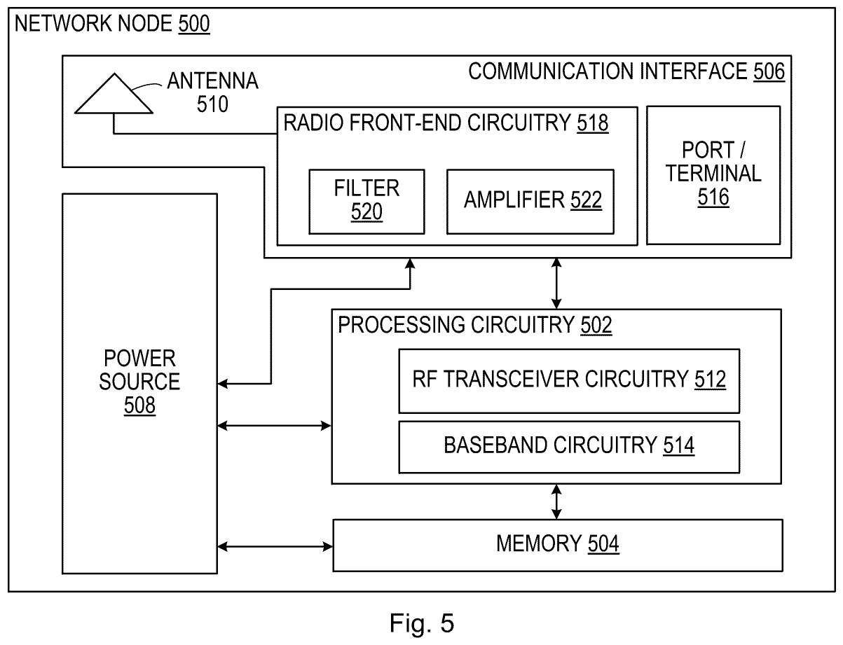

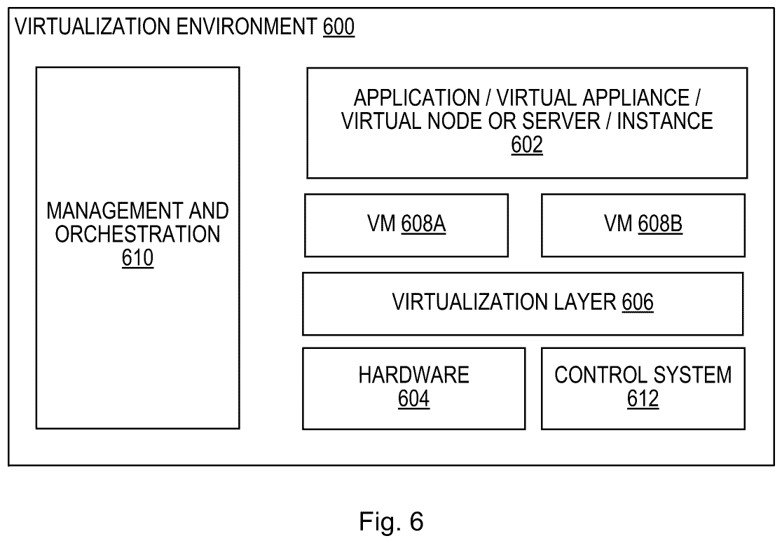

FIG. 2 is a flow chart illustrating a method performed by a network node in accordance with some embodiments. The network node may perform the method in response to executing suitably formulated computer readable code. The computer readable code may be embodied or stored on a computer readable medium, such as a memory chip, optical disc, or other storage medium. The computer readable medium may be part of a computer program product. The network node may be the network node 310 or network node 500 as described later with reference to FIGS. 3 and 5 respectively. Alternatively, the functionality of the network node can be implemented in virtualization environment 600 shown in FIG. 6.

In step 201, the network node can transmit (e.g. to a UE) one or more of the following types of information:
an indication of a remaining time period in which System Information, SI, will not be changed by the network;
a threshold that the remaining time period is to be compared with;
an indication of whether the remaining time period is less than the threshold;
a valueTag parameter;
a message indicating SI in SIBs that is or will be changed;
a message indicating SI in SIBs other than SIB1, that is or will be changed;
a message indicating that one or more UEs are allowed to postpone acquiring or reacquiring SI;
a set of one or more SIBs comprising only SI for use by IoT UEs.

Any of the indication of the remaining time period, the indication of whether the remaining time period is less than the threshold, and/or the threshold itself can be transmitted in a MIB.

The threshold may be specific to a UE that the threshold is transmitted to, or specific to a category of UEs.

The valueTag parameter can indicate a type of information that has been changed in SI.

The valueTag parameter can indicate whether essential SI has changed.

The message transmitted in step 201 can be a DCI message. The DCI message can comprise one or more bits used to indicate whether a respective SI or SIB is or will be changed.

The DCI message can be scrambled with any of: an identifier for a UE that the message is sent to, a RNTI for the UE, and a P-RNTI for the UE.

The message transmitted in step 201 can relate to a specific set of SI messages or SIBs, or relate to one or more SIBs comprising one or more specific parameters.

The message transmitted in step 201 may be transmitted in a MIB or in SIB1.

In embodiments where the message transmitted in step 201 indicates whether the UE is allowed to postpone acquiring or reacquiring the SI, a bit in the message can indicate whether the UE is allowed to postpone acquiring or reacquiring the SI.

In embodiments where the message transmitted in step 201 indicates whether the UE is allowed to postpone acquiring or reacquiring the SI, the message can be or comprise SI, a SIB, or dedicated control signalling.

FIG. 3 shows an example of a communication system 300 in accordance with some embodiments.

In the example, the communication system 300 includes a telecommunication network 302 that includes an access network 304, such as a radio access network (RAN), and a core network 306, which includes one or more core network nodes 308. The access network 304 includes one or more access network nodes, such as access network nodes 310a and 310b (which are interchangeably referred to as RAN network nodes 310 herein), or any other similar 3^{rd} Generation Partnership Project (3GPP) access node or non-3GPP access point (AP). Moreover, as will be appreciated by those of skill in the art, a RAN network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 302 includes one or more Open-RAN (ORAN) network nodes. An ORAN network node is a node in the telecommunication network 302 that supports an ORAN specification (e.g., a specification published by the O-RAN Alliance, or any similar organization) and may operate alone or together with other nodes to implement one or more functionalities of any node in the telecommunication network 302, including one or more network nodes 310 and/or core network nodes 308.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (RIC) (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies.

The access network nodes 310 facilitate direct or indirect connection of wireless devices (also referred to interchangeably herein as user equipment (UE)), such as by connecting UEs 312a, 312b, 312c, and 312d (one or more of which may be generally referred to as UEs 312) to the core network 306 over one or more wireless connections. The access network nodes 310 may be, for example, access points (APs) (e.g. radio access points), base stations (BSs) (e.g. radio base stations, Node Bs, evolved Node Bs (eNBs) and New Radio (NR) NodeBs (gNBs)).

Unless otherwise indicated, the general term ‘network node’ as used herein refers to access network nodes 310 and core network nodes 308.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The wireless devices/UEs 312 may be any of a wide variety of communication devices, including wireless devices arranged, configured, and/or operable to communicate wirelessly with the network nodes 310 and other communication devices. Similarly, the access network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the access network nodes 310 to one or more hosts, such as host 316. These connections may be direct or indirect via one or more intermediary networks or devices. In other examples, network nodes may be directly coupled to hosts. The core network 306 includes one more core network nodes (e.g. core network node 308) that are structured with hardware and software components. Features of these components may be substantially similar to those described with respect to the wireless devices/UEs, access network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2^{nd} Generation (2G), 3^{rd} Generation (3G), 4^{th} Generation (4G), 5^{th} Generation (5G) standards, or any applicable future generation standard (e.g. 6^{th} Generation (6G)); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 302 is a cellular network that implements 3GPP standardized features. Accordingly, the telecommunications network 302 may support network slicing to provide different logical networks to different devices that are connected to the telecommunication network 302. For example, the telecommunications network 302 may provide Ultra Reliable Low Latency Communication (URLLC) services to some UEs, while providing Enhanced Mobile Broadband (eMBB) services to other UEs, and/or Massive Machine Type Communication (mMTC)/Massive Internet of Things (IoT) services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single- or multi-radio access technology (RAT) or multi-standard mode. For example, a UE may operate with any one or combination of Wi-Fi, NR (New Radio) and LTE, i.e. being configured for multi-radio dual connectivity (MR-DC), such as E-UTRAN (Evolved-UTRA (UMTS Terrestrial Radio Access) Network) New Radio—Dual Connectivity (EN-DC).

In the example illustrated in FIG. 3, the hub 314 communicates with the access network 304 to facilitate indirect communication between one or more UEs (e.g. UE 312c and/or 312d) and access network nodes (e.g. access network node 310b). In some examples, the hub 314 may be a controller, router, a content source and analytics node, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a Virtual Reality VR headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular if one or more of the UEs are low energy Internet of Things (IoT) devices.

The hub 314 may have a constant/persistent or intermittent connection to the network node 310b. The hub 314 may also allow for a different communication scheme and/or schedule between the hub 314 and UEs (e.g. UE 312c and/or 312d), and between the hub 314 and the core network 306. In other examples, the hub 314 is connected to the core network 306 and/or one or more UEs via a wired connection. Moreover, the hub 314 may be configured to connect to a Machine-to-Machine (M2M) service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub—that is, a hub whose primary function is to route communications to/from the UEs from/to the network node 310b. In other embodiments, the hub 314 may be a non-dedicated hub—that is, a device which is capable of operating to route communications between the UEs and network node 310b, but which is additionally capable of operating as a communication start and/or end point for certain data channels.

FIG. 4 shows a wireless device or UE 400 in accordance with some embodiments.

As used herein, a UE refers to a device capable, configured, arranged and/or operable to communicate wirelessly with network nodes and/or other UEs. Examples of a wireless device/UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, an Internet-of-Things (IoT) device, a Zero Energy-IoT (ZE-IoT) device, an Ambient IoT device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 400 includes processing circuitry 402 that is operatively coupled via a bus 404 to an input/output interface 406, a power source 408, a memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs). The processing circuitry 402 may be operable to provide, either alone or in conjunction with other UE 400 components, such as the memory 410, to provide UE 400 functionality. For example, the processing circuitry 402 may be configured to cause the UE 402 to perform the methods as described herein.

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g. an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or integrated SIM (ISIM), other memory, or any combination thereof. The UICC may for example be an embedded UICC (eUICC), integrated UICC (iUICC) or a removable UICC commonly known as ‘SIM card.’ The memory 410 may allow the UE 400 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g. another UE or a network node in an access network). Each transceiver may include a transmitter 418 and/or a receiver 420 appropriate to provide network communications (e.g. optical, electrical, frequency allocations, and so forth). Moreover, the transmitter 418 and receiver 420 may be coupled to one or more antennas (e.g. antenna 422) and may share circuit components, software or firmware, or alternatively be implemented separately.

In some embodiments, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) or other Global Navigation Satellite System (GNSS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an IoT device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 400 shown in FIG. 4.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 5 shows an access network node 500 or RAN network node 500 in accordance with some embodiments.

As used herein, access network node or RAN network node refers to equipment capable, configured, arranged and/or operable to communicate directly or indirectly with a UE and/or with other RAN network nodes or equipment or core network nodes, in a telecommunication network. Examples of access network nodes include, but are not limited to, access network nodes such as APs (e.g. radio access points), base stations (BSs) (e.g. radio base stations, Node Bs, evolved Node Bs (eNBs) and NR NodeBs (gNBs)), Open RAN (O-RAN) nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A RAN network node may also include one or more (or all) parts of a distributed radio base station such as centralized digital units, distributed units (e.g., in an O-RAN access node), and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of access network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The RAN network node 500 includes processing circuitry 502, a memory 504, a communication interface 506, and a power source 508, and/or any other component, or any combination thereof. The RAN network node 500 may be composed of multiple physically separate components (e.g. a NodeB component and a RNC component, or a BTS component and a BSC component, etc.), which may each have their own respective components. In certain scenarios in which the RAN network node 500 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the RAN network node 500 may be configured to support multiple radio access technologies (RATs). In such embodiments, some components may be duplicated (e.g. separate memory 504 for different RATs) and some components may be reused (e.g. a same antenna 510 may be shared by different RATs). The RAN network node 500 may also include multiple sets of the various illustrated components for different wireless technologies integrated into RAN network node 500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within RAN network node 500.

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other RAN network node 500 components, such as the memory 504, to provide network node 500 functionality. For example, the processing circuitry 502 may be configured to cause the RAN network node to perform the methods as described herein.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the RAN network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signalling and/or data between network nodes, the access network, the core network, and/or a UE. As illustrated, the communication interface 506 comprises port(s)/terminal(s) 516 to send and receive data, for example to and from a network over a wired connection.

The communication interface 506 also includes radio front-end circuitry 518 that may be coupled to, or in certain embodiments a part of, the antenna 510. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the access network node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the RAN network node 500 through an interface or port.

The antenna 510, communication interface 506, and/or the processing circuitry 502 may be configured to perform any receiving operations and/or certain obtaining operations described herein as being performed by the network node. Any information, data and/or signals may be received from a UE, another network node and/or any other network equipment. Similarly, the antenna 510, the communication interface 506, and/or the processing circuitry 502 may be configured to perform any transmitting operations described herein as being performed by the network node. Any information, data and/or signals may be transmitted to a UE, another network node and/or any other network equipment.

The power source 508 provides power to the various components of RAN network node 500 in a form suitable for the respective components (e.g. at a voltage and current level needed for each respective component). The power source 508 may further comprise, or be coupled to, power management circuitry to supply the components of the network node 500 with power for performing the functionality described herein. For example, the RAN network node 500 may be connectable to an external power source (e.g. the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the RAN network node 500 may include additional components beyond those shown in FIG. 5 for providing certain aspects of the network node's functionality, including any of the functionality described herein and/or any functionality necessary to support the subject matter described herein. For example, the RAN network node 500 may include user interface equipment to allow input of information into the RAN network node 500 and to allow output of information from the RAN network node 500. This may allow a user to perform diagnostic, maintenance, repair, and other administrative functions for the RAN network node 500.

FIG. 6 is a block diagram illustrating a virtualization environment 600 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 600 hosted by one or more of hardware nodes, such as a hardware computing device that operates as an access network node, a wireless device/UE, a core network node, or host. Further, in embodiments in which the virtual node does not require radio connectivity (e.g. a core network node or host), then the node may be entirely virtualized. In some embodiments, the virtualization environment 600 includes components defined by the Open-RAN (O-RAN) Alliance, such as an O-Cloud environment orchestrated by a Service Management and Orchestration Framework via an O-2 interface.

Applications 602 (which may alternatively be called software instances, virtual appliances, network functions, virtual nodes, virtual network functions, etc.) are run in the virtualization environment 600 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 606 (also referred to as hypervisors or virtual machine monitors (VMMs)), provide VMs 608a and 608b (one or more of which may be generally referred to as VMs 608), and/or perform any of the functions, features and/or benefits described in relation with some embodiments described herein. The virtualization layer 606 may present a virtual operating platform that appears like networking hardware to the VMs 608.

The VMs 608 comprise virtual processing, virtual memory, virtual networking or interface and virtual storage, and may be run by a corresponding virtualization layer 606. Different embodiments of the instance of a virtual appliance 602 may be implemented on one or more of VMs 608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 608 may be a software implementation of a physical machine that runs programs as if they were executing on a physical, non-virtualized machine. Each of the VMs 608, and that part of hardware 604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 608 on top of the hardware 604 and corresponds to the application 602.

Hardware 604 may be implemented in a standalone network node with generic or specific components. Hardware 604 may implement some functions via virtualization. Alternatively, hardware 604 may be part of a larger cluster of hardware (e.g. such as in a data center or CPE) where many hardware nodes work together and are managed via management and orchestration 610, which, among others, oversees lifecycle management of applications 602. In some embodiments, hardware 604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 612 which may alternatively be used for communication between hardware nodes and radio units.

Although the computing devices described herein (e.g. UEs, RAN network nodes, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### Embodiments

### Group A Embodiments

1. A method performed by a user equipment, UE, the method comprising:
   determining whether to acquire or reacquire system information, SI, and
   if it is determined to acquire or reacquire SI, acquiring or reacquiring the SI.
2. The method of Embodiment 1, wherein the steps of determining and acquiring or
reacquiring SI relate to SI in System Information Block 1, SIB1.
3. The method of embodiment 1, wherein the SI is in a set of one or more System Information Blocks, SIBs, only comprising SI for use by Internet of Things, IoT, UEs.
4. The method of any of embodiments 1-3, wherein determining whether to acquire or reacquire SI is based on any one or more of:
   an indication of a remaining time period during which SI will not be changed by the network;
   a comparison of the remaining time period and a threshold;
   an energy level of the UE;
   an estimate of the energy level of the UE after acquiring or reacquiring the SI;
   a comparison of the energy level or estimated energy level to an amount of energy required by the UE to acquire or reacquire the SI;
   a comparison of the energy level or estimated energy level to an amount of energy required by the UE to transmit data and/or receive data after acquiring or reacquiring the SI;
   whether the UE is to perform an action that applies or uses the SI; and
   a valueTag parameter.
5. The method of embodiment 4, wherein the step of determining comprises determining not to acquire or reacquire SI if the remaining time period is less than the threshold.
6. The method of embodiment 4 or 5, wherein the step of determining comprises determining not to acquire or reacquire SI if the energy level or estimated energy level is below an amount required to acquire or reacquire the SI.
7. The method of embodiment 4, 5 or 6, wherein the step of determining comprises determining not to acquire or reacquire SI if the energy level or estimated energy level is below an amount required to transmit data and/or receive data after acquiring or reacquiring the SI.
8. The method of any of embodiments 1-7, wherein the SI is in System Information Block 1, SIB1, and wherein the method further comprises:
   receiving a message indicating SI in other System Information Blocks, SIBs, that is or will be changed;
   and one or both of:
   determining not to acquire or reacquire the SI in SIB1; and
   acquiring or reacquiring the SI in the other SIBs indicated in the message.
9. The method of any of embodiments 1-8, wherein the method further comprises: receiving a message indicating whether the UE is allowed to postpone acquiring or reacquiring the SI.
10. The method of embodiment 9, wherein the step of determining comprises determining to postpone acquiring or reacquiring the SI if the received message indicates that the UE is allowed to postpone acquiring or reacquiring the SI.
11. The method of embodiment 9 or 10, wherein the method further comprises:
   after postponing the acquisition or reacquisition of the SI, acquiring or reacquiring the SI prior to an action by the UE that requires information in the SI.
12. The method of any of embodiments 1-11, wherein the SI is System Information Block 1, SIB1, and if it is determined that SIB1 is not to be acquired or reacquired, the method further comprises:
   without acquiring or reacquiring SIB1 or a Master Information Block, MIB, acquiring or reacquiring SI in System Information Blocks, SIBs, other than SIB1.
13. The method of any of embodiments 1-12, wherein if it is determined to not acquire or reacquire SI in System Information Block 1, SIB1, the method further comprises suspending one or more of:
   acquiring or reacquiring SI other than System Information Block 1, SIB1;
   paging monitoring;
   downlink, DL, measurements;
   signalling/data reception in DL; and
   signalling/data transmission in uplink, UL.

### Group B Embodiments

14. A method performed by a network node, the method comprising:
   transmitting one or more of:
      an indication of a remaining time period in which System Information, SI, will not be changed by the network;
      a valueTag parameter;
      a message indicating SI in System Information Blocks, SIBs, that is or will be changed;
      a message indicating SI in SIBs other than SIB1, that is or will be changed;
      a message indicating that one or more User Equipments, UEs, are allowed to postpone acquiring or reacquiring SI;
      a set of one or more System Information Blocks, SIBs, comprising only SI for use by Internet of Things, IoT, UEs.

### Group C Embodiments

15. A computer program product comprising a computer readable medium having computer readable code embodied therein, the computer readable code being configured such that, on execution by a suitable computer or processor, the computer or processor is caused to perform the method of any of the Group A embodiments or the Group B embodiments.
16. A user equipment, UE, configured to perform the method of any of the Group A embodiments.
17. A user equipment, UE, comprising a processor and a memory, said memory containing instructions executable by said processor whereby said UE is operative to perform the method of any of the Group A embodiments.
18. A first radio access network, RAN, node, configured to perform the method of any of the Group B embodiments.
19. A first radio access network, RAN, node comprising a processor and a memory, said memory containing instructions executable by said processor whereby said first RAN node is operative to perform the method of any of the Group B embodiments.
20. A user equipment, UE, comprising:
   processing circuitry configured to cause the user equipment to perform any of the steps of any of the Group A embodiments; and
   power supply circuitry configured to supply power to the processing circuitry.
21. A network node, the network node comprising:
   processing circuitry configured to cause the network node to perform any of the steps of any of the Group B embodiments;
   power supply circuitry configured to supply power to the processing circuitry.
22. A user equipment, UE, the UE comprising:
   an antenna configured to send and receive wireless signals;
   radio front-end circuitry connected to the antenna and to processing circuitry, and configured to condition signals communicated between the antenna and the processing circuitry; the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and a battery connected to the processing circuitry and configured to supply power to the UE.

1. A method performed by a user equipment, UE, the method comprising:
determining whether to acquire or reacquire system information, SI; and
wherein determining not to acquire or reacquire SI if the energy level or estimated energy level is below an amount required to acquire or reacquire the SI and if it is determined to acquire or reacquire SI, acquiring or reacquiring the SI.

2. The method of claim 1, wherein the steps of determining and acquiring or reacquiring SI relate to SI in System Information Block 1, SIB1.

3. The method of claim 1, wherein the SI is in a set of one or more System Information Blocks, SIBs, only comprising SI for use by Internet of Things, IoT, UEs.

4. The method of claim 1, wherein determining whether to acquire or reacquire SI is based on any one or more of:
an indication of a remaining time period during which SI will not be changed by the network;
a comparison of the remaining time period and a threshold;
an indication of whether the remaining time period is less than the threshold;
an energy level of the UE;
an estimate of the energy level of the UE after acquiring or reacquiring the SI;
a comparison of the energy level or estimated energy level to an amount of energy required by the UE to acquire or reacquire the SI;
a comparison of the energy level or estimated energy level to an amount of energy required by the UE to transmit data and/or receive data after acquiring or reacquiring the SI;
determining that the SI has changed;
whether the UE is to perform an action that applies or uses the SI; and
a valueTag parameter.

5. The method of claim 4, wherein the step of determining comprises determining not to acquire or reacquire SI if the remaining time period is less than the threshold.

6. (canceled)

7. The method of claim 4, wherein the step of determining comprises determining not to acquire or reacquire SI if the energy level or estimated energy level is below an amount required to transmit data and/or receive data after acquiring or reacquiring the SI.

8. The method of claim 4, wherein any of the indication of the remaining time period, the threshold, and the indication of whether the remaining time period is less than the threshold, are received from a network node.

9. The method of claim 4, wherein any of the indication of the remaining time period, the threshold, and the indication of whether the remaining time period is less than the threshold, are received in a Master Information Block, MIB.

10-26. (canceled)

27. A method performed by a network node, the method comprising:
transmitting one or more of:
an indication of a remaining time period in which System Information, SI, will not be changed by the network;
a threshold that the remaining time period is to be compared with;
an indication of whether the remaining time period is less than the threshold;
a valueTag parameter;
a message indicating SI in System Information Blocks, SIBs, that is or will be changed;
a message indicating SI in SIBs other than SIB1, that is or will be changed;
a message indicating that one or more User Equipments, UEs, are allowed to postpone acquiring or reacquiring SI; and
a set of one or more System Information Blocks, SIBs, comprising only SI for use by Internet of Things, IoT, UEs.

28. The method of claim 27, wherein any of: the indication of the remaining time period, the indication of whether the remaining time period is less than the threshold, and/or the threshold, are transmitted in a Master Information Block, MIB.

29. The method of claim 27, wherein the threshold is specific to a UE that the threshold is transmitted to, or specific to a category of UEs.

30. The method of claim 27, wherein the valueTag parameter indicates a type of information that has been changed in SI.

31. The method of claim 30, wherein the valueTag parameter indicates whether essential SI has changed.

32. The method of claim 27, wherein the transmitted message is a Downlink Control Information, DCI, message.

33-40. (canceled)

41. A user equipment, UE, comprising a processor and a memory, said memory containing instructions executable by said processor whereby said UE is operative to perform operations comprising:
determine whether to acquire or reacquire system information, SI; and
wherein determining not to acquire or reacquire SI if the energy level or estimated energy level is below an amount required to acquire or reacquire the SI and if it is determined to acquire or reacquire SI, acquiring or reacquiring the SI.

42. (canceled)

43. A network node comprising a processor and a memory, said memory containing instructions executable by said processor whereby said network node is operative to perform perform operations comprising:
transmit one or more of:
an indication of a remaining time period in which System Information, SI, will not be changed by the network;
a threshold that the remaining time period is to be compared with;
an indication of whether the remaining time period is less than the threshold;
a valueTag parameter;
a message indicating SI in System Information Blocks, SIBs, that is or will be changed;
a message indicating SI in SIBs other than SIB1, that is or will be changed;
a message indicating that one or more User Equipments, UEs, are allowed to postpone acquiring or reacquiring SI; and
a set of one or more System Information Blocks, SIBs, comprising only SI for use by Internet of Things, IoT, UEs.
